(19) United States
(12) Patent Application Publication
(10) Pub. No.: US 2008/0184710 A1
(43) Pub. Date: Aug. 7, 2008

(54) Multistage Thermoelectric Water Cooler

(76) Inventor: Roger S. DeVilbiss, Wichita Falls, TX (US)

Correspondence Address: BAKER BOTTS L.L.P., 2001 ROSS AVENUE, SUITE 600, DALLAS, TX, 75201-2980, US

(21) Appl. No.: 11/671,897

(22) Filed: Feb. 6, 2007

(51) Int. Cl. F25B 21/02; B67D 5/62

(52) U.S. Cl. 62/3.2; 62/389; 62/3.7

(57) ABSTRACT

In one embodiment of the invention, a system for controlling the temperature of water in a water reservoir includes a water reservoir, an inlet operable to deliver water to the water reservoir, an outlet operable to dispense at least a portion of the water from the water reservoir, and a staged water cooler having a first thermoelectric cooler stage coupled to a second thermoelectric cooler stage, the staged water cooler operable to control the temperature of the water in the water reservoir.

### TECHNICAL FIELD OF THE INVENTION

The invention relates generally to water coolers and, more specifically, to a multistage thermoelectric water cooler.

### BACKGROUND OF THE INVENTION

There are four basic types of water or drink dispensers: bottled water dispensers, point-of-use dispensers, pressurized water dispensers and soft drink fountains. Bottled water dispensers manually replace a bottle to supply the water. Point-of-use dispensers are freestanding appliances that use line pressure activated by a float switch to maintain a water level. Pressurized water dispensers, also know as refrigerated water fountains, are typically installed in non-residential buildings, and are purchased at the time of construction.

Current designs for the above dispensers use small compressor-based cooling systems that dissipate the heat to ambient via forced air. An evaporator cools a reservoir and the condenser/fan arrangement dissipates the heat. This approach, depending on the size of the cooling system, consumes energy, produces noise, and then dissipates this heat into an air conditioned environment, which adds cooling costs to the building. Since this approach uses a fan to dissipate the heat to the environment, noise and vibration is generated and air is circulated in and around the water cooler that is unwarranted in many school, manufacturing, office, or hospital applications.

### SUMMARY OF THE INVENTION

In one embodiment of the invention, a system for controlling the temperature of water in a water reservoir includes a water reservoir, an inlet operable to deliver water to the water reservoir, an outlet operable to dispense at least a portion of the water from the water reservoir, and a staged water cooler operable to control the temperature of water in the water reservoir. The staged water cooler includes a first thermoelectric cooler stage coupled thermally to a second thermoelectric cooler stage.

In another embodiment of the invention, a staged water cooler includes a water reservoir operable to hold water, a first thermoelectric cooler stage coupled to the water reservoir, and a second thermoelectric cooler stage coupled to the first thermoelectric cooler stage. The first thermoelectric cooler stage extracts heat from the water in the water reservoir. The second thermoelectric cooler stage extracts heat from the first thermoelectric cooler stage.

In another embodiment of the invention, a system for controlling the temperature of water in a hot water reservoir and a cold water reservoir includes a hot water reservoir, a cold water reservoir, a water supply, a hot water dispenser, a cold water dispenser, a first staged thermoelectric device, and a second staged thermoelectric device. The water supply delivers water to the cold water reservoir and to the hot water reservoir. The hot water dispenser dispenses a portion of water from the hot water reservoir. The cold water dispenser dispenses a portion of water from the cold water reservoir. The first staged thermoelectric device includes a first thermoelectric stage coupled to a second thermoelectric stage. The first staged thermoelectric device increases the temperature of water in the hot water reservoir. The second staged thermoelectric device has a third thermoelectric stage coupled to a fourth thermoelectric stage. The second staged thermoelectric device decreases the temperature of water in the cold water reservoir.

In yet another embodiment of the invention, a method for controlling the temperature of the water in a water reservoir includes receiving water at a water reservoir, extracting heat from the water in the water reservoir using a first thermoelectric cooler stage, and extracting heat from the first thermoelectric cooler stage using a second thermoelectric cooler stage.

Various embodiments of the invention provide a number of technical advantages. In one embodiment, a multistage thermoelectric water cooler provides improved operational efficiency by consuming less power to reduce energy bills. Such a water cooler may be compact with no moving parts, which facilitates quiet operation and reduces wear and tear. In addition, minimal to no air movement or associated air filter is required to discharge heat into the environment. Reduced power requirements improves maintenance and operational costs. In another embodiment, a multistage thermoelectric water cooler provides improved heat pumping capacity, in particular at large delta temperatures. Embodiments of the invention include all, some, or none of these advantages.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1 is a schematic of a thermoelectric water cooler according to one embodiment of the invention;

FIG. 2 is a perspective view of a water reservoir for use in the thermoelectric water cooler of FIG. 1;

FIG. 3 is a cross-section of the water reservoir of FIG. 1;

FIG. 4 is a schematic of a water filter/bubbler combination unit;

FIG. 5 is a schematic of a dual power supply approach using an AC/DC non-isolated power supply for full power and a AC/DC power supply for standby power;

FIG. 6 is a flowchart illustrating a method of operating a thermoelectric water cooler;

FIG. 7 is a schematic of a water reservoir system for use in a thermoelectric water cooler;

FIG. 8 is a cross-section of a water reservoir, heat exchangers, and a two stage arrangement of thermoelectric coolers;

FIG. 9 is a schematic of a multistage thermoelectric water cooler;

FIG. 10 is a schematic of an exit tube manifold, a cover of a water reservoir, and a two stage arrangement of thermoelectric coolers; and

FIG. 11 is a schematic of a multistage thermoelectric water cooler with a cold water reservoir and a hot water reservoir.

### DETAILED DESCRIPTION OF EXAMPLE EMBODIMENTS OF THE INVENTION

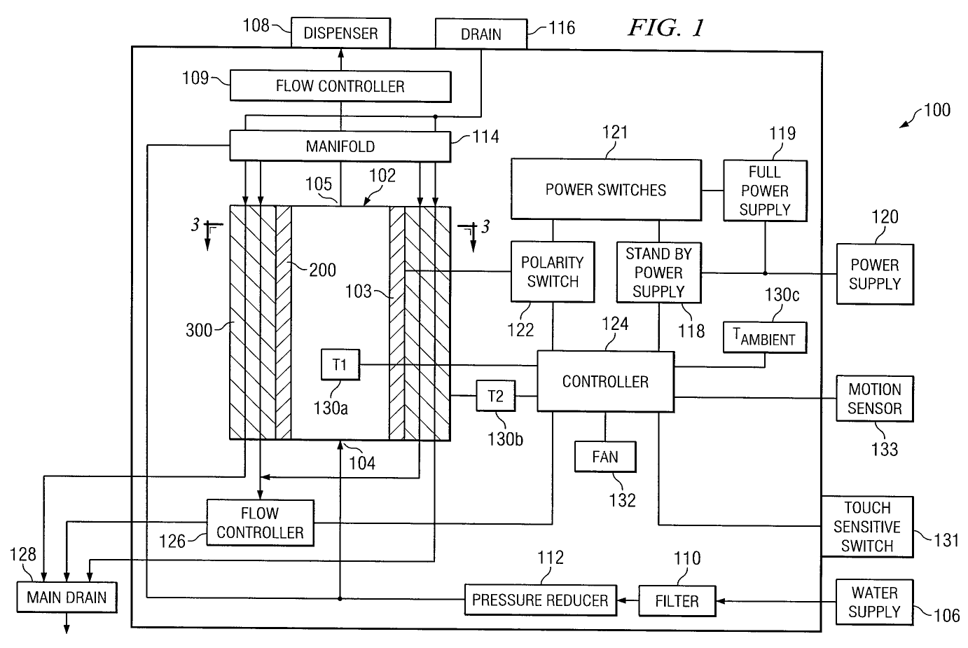

Example embodiments of the present invention and their advantages are best understood by referring now to FIGS. 1 through 10 of the drawings.

FIG. 1 is a schematic of a thermoelectric water cooler 100 with a water reservoir 102. Water cooler 100 represents any suitable water cooler or heater, such as a pressurized water dispenser, a point-of-use water dispenser, portable water coolers, a bottle water dispenser, water coolers for automotive applications, and other devices that store and utilize cooled and/or heated potable liquids. In the illustrated embodiment, water cooler 100 includes water reservoir 102 having an inlet 104, an outlet 105, and a main body 103. Water reservoir 102 receives water from a water supply 106 and is dispensed via a dispenser 108 when a user desires water.

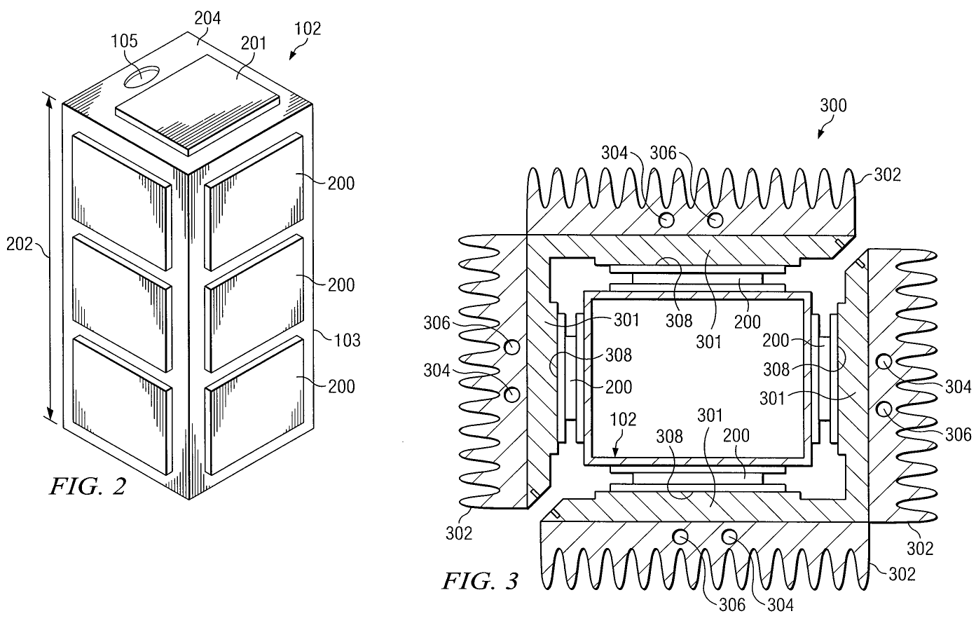

Water reservoir 102 has a plurality of thermoelectric coolers 200 disposed about a perimeter of main body 103 that are operable to control the temperature of the water inside water reservoir 102. Thermoelectric coolers 200 are described in further detail below in conjunction with FIG. 2.

Water cooler 100, as illustrated in FIG. 1, also includes a heat exchanger 300 coupled to thermoelectric coolers 200. As used throughout this specification, coupled refers to being directly connected or indirectly connected through one or more components. Heat exchanger 300 is described in further detail below in conjunction with FIG. 3. In addition, water cooler 100 also includes one or more filters 110, a pressure reducer 112, a manifold 114, a drain 116, a standby power supply 118 and full power supply 119 coupled to power supply 120, power switches 121, a polarity switch 122, a controller 124, a flow controller 126, a main drain 128, a plurality of temperature sensors 130, an optional fan 132, and a motion sensor 133. More, fewer, or different components of water cooler 100 than those shown in FIG. 1 may be used.

Water supply 106 may be any suitable supply of water. Typically, water supply 106 is water existing in a pressurized line that runs to a residence or commercial building. Water from water supply 106 enters water cooler 100 and is filtered by a large particle water filter 110 before being delivered to a pressure reducer 112 in order to reduce the pressure of the water from water supply 106. The water may then be filtered again if so desired before being delivered to water reservoir 102. In one lightweight and portable embodiment of thermoelectric water cooler 100, nonpotable water from water supply 106 is filtered by one or more filters 110 to make the water potable. In such an embodiment, one or more filters 110 includes a reverse osmosis, a carbon, or other suitable type of filter to remove impurities from the water from water supply 106 before delivering the filtered water to water reservoir 102. In some cases, the potable water is improved by additional filtering and/or conditioning. Another embodiment not necessarily lightweight or portable is simply a filter 110 that is easily accessible and replaceable in a traditional commercial pressurized water dispenser. Another such embodiment includes one or more filters 110 that are removable and located within water reservoir 102. In one embodiment, after the pressure of the water is reduced by pressure reducer 112 to any suitable amount, at least some of the water is delivered to a manifold 114 where it is stored and subsequently used in heat exchanger 300, as described in further detail below.

Water that is stored in water reservoir 102 is cooled by thermoelectric coolers 200 and maintained at a predetermined temperature during a standby mode when water cooler 100 is not in use. Any suitable predetermined temperature is used. However, in one embodiment, the water in water reservoir 102 is maintained at a temperature of 50° F. The amount of power delivered to thermoelectric coolers 200 by standby power supply 118 or full power supply 119 determines the temperature of water within water reservoir 102.

When a user desires to obtain water from water cooler 100, a user uses dispenser 108 in order to obtain the water from water reservoir 102 via flow controller 109. Any suitable dispenser is used; however, in one embodiment, dispenser 108 is a bubbler that is found on many pressurized water coolers.

In some embodiments, a touch sensitive switch 131 is used to control flow controller 109 in order to dispense water from water reservoir 102. Touch sensitive switch 131 turns flow controller 109 on and off and meets the American Disabilities Act requirements. As one example, touch sensitive switch 131 is one of the QT110 Family Qtouch™ Sensor ICs by Quantum Research Group.

At least some of the water that is being dispensed is collected and drained by drain 116 is diverted to either main drain 128 or, in some embodiments, utilized within heat exchanger 300 for cooling thermoelectric coolers 200, as described in greater detail below. During the use mode, when a user is obtaining water through dispenser 108, additional power is delivered to thermoelectric coolers 200 by either full power supply 119 or standby power supply 118 in order to keep the water within water reservoir 102 at the desired temperature. This is because as water is being dispensed by dispenser 108, additional water from water supply 106 that is at a higher temperature than the desired temperature is being supplied to water reservoir 102.

As described in further detail below, water flows proximate the hot side of thermoelectric coolers 200 if the temperature of such water is cooler than the ambient temperature to improve system performance. If the water does not provide adequate cooling in a low power use mode within a certain time frame, full power supply 119 or standby power supply 118 is used to cool the temperature of water reservoir 102 to the desired temperature. If the temperature of water reservoir 102 drops below a predetermined threshold, e.g. 46° F., power to thermoelectric coolers 200 is turned off. Heating is used if the ambient temperature drops below freezing (32° F.).

Although any suitable power delivery may be used, in the illustrated embodiment, power is delivered to thermoelectric coolers 200 via one of two power supplies 118 or 119 via power supply 120, which may come from a standard wall socket or power cord. A fuse or circuit breaker (not illustrated) is used to provide safety protection.

A polarity switch 122 may be used to reverse the polarity of thermoelectric coolers 200 in order to change from cooled water to hot water or hot water to cooled water. For example, if water is maintained at approximately 50° F. in water reservoir 102 and the user desires hot water, then polarity switch 122 switches the polarity of thermoelectric coolers 200 in order to heat the water. Any suitable amount of heating or cooling in any suitable amount of time may be used.

A suitable controller 124 may be utilized to control the power delivered to thermoelectric coolers 200 in addition to controlling other functions of water cooler 100, such as the switching of the power supplies via switches 121, the switching of the polarity delivered to thermoelectric coolers 200, the use of heat exchanger 300, optional fan 132, and other suitable functions. Any suitable controller may be used, and independent analog circuitry may also be used.

Controller 124 may be coupled to temperature sensors 130a, 130b, 130c in order to maintain the temperature of the water in water reservoir 102 under different environmental and use conditions. For example, if ambient temperature rises, as detected by temperature sensor 130c, then more than likely the temperature of water in water reservoir 102, as detected by temperature sensor 130a, will rise. Controller 124 may either direct more power to be delivered to thermoelectric coolers 200 or direct drain water from drain 116 or water stored in manifold 114 through heat exchanger 300 in order to keep the temperature of the water within water reservoir 102 at the desired temperature.

Fan 132 is used for forced convection across heat exchanger 300 for additional cooling purposes. Any suitable fan, such as a DC fan, may be used. In one case, a fan with a fan speed control is used. One advantage is that during standby mode, natural convection may be the only convection needed for maintaining the temperature of water within water reservoir 102 at the desired temperature.

Flow controller 126 is coupled to main drain 128 and controls the flow of water through heat exchanger 300. Any suitable flow controller, such as a suitable solenoid valve, may be utilized. Generally, flow controller 126 may direct that only drain water from drain 116 be directed through heat exchanger 300, or may direct that only water stored in manifold 114 be directed through heat exchangers 300.

Motion sensor 133 is any suitable motion detection device coupled to controller 124 in order to control power supplies 118, 119. For example, if motion sensor 133 detects no movement within a predetermined time period, then controller 124 switches the power delivery to thermoelectric coolers 200 from full power supply 119 to standby power supply 118 or from standby power supply to zero power delivery. Any suitable time period is used and any suitable control of power supplies 118, 119 is used.

FIG. 2 is a perspective view of water reservoir 102. Main body 103 of water reservoir 102 may have any suitable size and shape and may be formed from any suitable material. For example, as illustrated in FIG. 2, main body 103 may be rectangularly shaped and be formed from copper. In other embodiments, main body 103 is formed from other suitable metals, such as aluminum or stainless steel, and includes coatings, if necessary, to meet NSF-ANSI-61 requirements. In one particular embodiment, the approximate dimensions of main body 103 are two inch width by two inch depth by approximately twelve inches long. Although not illustrated in FIG. 2, water reservoir 102 may include baffles for effective distribution of temperature.

Alternatively, in one particular embodiment, an approach may be to sandwich sixteen thermoelectric coolers 200 in a 0.5″ thick×1.6″×14″ water manifold with thermoelectric coolers 200 and two heat sinks on each side that are 1.8″ wide×14″ long while maximizing the coverage of the thermoelectric coolers 200 around the reservoir. Counter flow of the cooling water to the reservoir water may be used in this embodiment as well as previous embodiments.

The thermoelectric coolers 200 coupled to the outside surface of main body 103 cover a significant portion of the surface area of main body 103. Thus, depending on the type of thermoelectric coolers utilized, thermoelectric coolers 200 may be disposed about a perimeter of, as well as along a length 202 of, main body 103. Preferably, the gaps between thermoelectric coolers 200 are minimized so as to minimize any thermal shorts from water reservoir 102 to the heat sinks of main body 103. Additional thermoelectric coolers, such as thermoelectric cooler 201, may be coupled to a top 204 of water reservoir 102 or a bottom of water reservoir 102.

Water cooler 100 may use any suitable thermoelectric coolers 200. However, in one particular embodiment of the invention, each of the thermoelectric coolers are model number DT12-4-01L on the first stage and DT12-6-01L on the second stage manufactured by Marlow Industries. Thermoelectric coolers 200 may be coupled to main body 103 in any suitable manner and any suitable number of thermoelectric coolers 200 are used. In one embodiment, between thirteen and sixteen thermoelectric coolers 200 are utilized for controlling the temperature of the water within water reservoir 102. Preferably, thermoelectric coolers 200 are electrically coupled in series to take advantage of the low cost and efficient line rectified full power voltage.

Thermoelectric coolers 200 are made of any suitable material or combination of materials. In one embodiment, thermoelectric coolers 200 are made of ceramic material. Thermoelectric coolers 200 made of ceramic material may provide electrical insulation from water reservoir 102. In one embodiment, each thermoelectric cooler 200 includes a moisture seal around one or more of its surfaces.

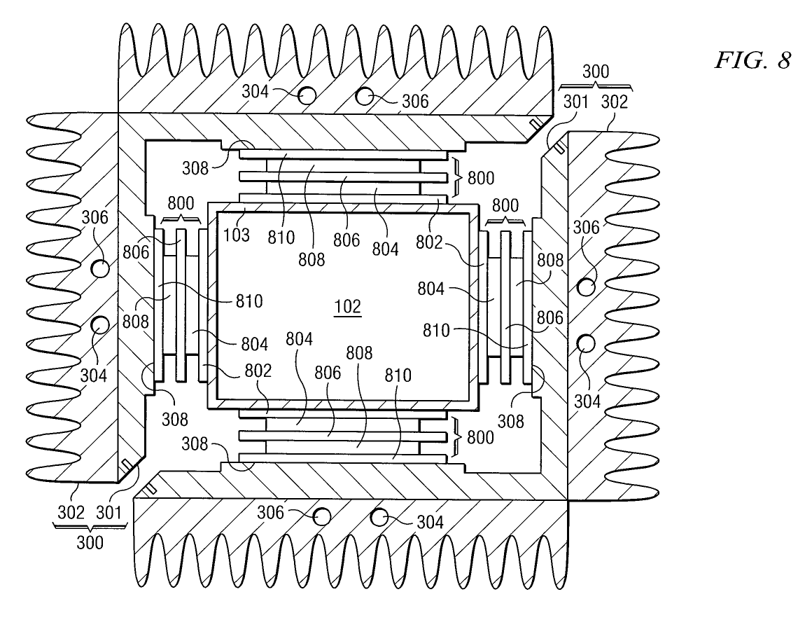

Thermoelectric coolers 200 may be arranged in a single stage or in multiple stages. One embodiment of thermoelectric water cooler 100 with two stages is described in detail in FIG. 8. Each stage refers to one or more thermoelectric coolers 200 electrically coupled together. In a multiple stage arrangement, multiple stages of thermoelectric coolers 200 are arranged as a series of thermally interfacing layers of thermoelectric coolers 200. Each successive stage is thermally coupled to the previous stage to remove heat from the previous stage. In some cases, stages are selectively activated to remove heat. In other cases, an individual thermoelectric cooler 200 is selectively activated to remove heat. Water cooler 100 contemplates any single stage or multiple stage arrangement of thermoelectric coolers 200 and any electrical or thermal coupling among those thermoelectric coolers 200 and stages.

FIG. 3 illustrates a cross-section of water reservoir 102, heat exchangers 300, and thermoelectric coolers 200. Heat exchanger 300 includes a hot side 308 coupled to thermoelectric coolers 200, and a plurality of fins 302. This is assuming that the thermoelectric coolers are being used to cool the water inside water reservoir 102. Heat exchanger 300 may be formed from any suitable material and may have any suitable size and shape. In one embodiment, during maintenance power conditions, heat exchanger 300 with fins 302 provide enough surface area for natural convection to keep the hot sides 308 of thermoelectric coolers 200 at a low enough temperature to provide water within water reservoir 102 at the desired set point. However during use conditions, it may be necessary to provide additional cooling to the hot side 308 of thermoelectric coolers 200 by either forced convection via fan 132 or by running water through heat exchanger 300.

For example, heat exchanger 300 also includes a first set of cooling channels 304 and a second set of cooling channels 306. Cooling channels 304 are coupled to drain 116 (FIG. 1) and allow water to flow from drain 116 through heat exchangers 300 in order to provide cooling to hot side 308 of thermoelectric coolers 200. On the other hand, cooling channels 306 are coupled to manifold 114 (FIG. 1) and allow water stored in manifold 114 that comes from water supply 106 to flow through heat exchanger 300 for the cooling of hot side 308 of thermoelectric coolers 200. The use of either cooling channels 304, cooling channels 306, or both, may be controlled by controller 124 (FIG. 1). The drain water may also be used to precool the water prior to entrance into water reservoir 102; however, a preferred embodiment is illustrated.

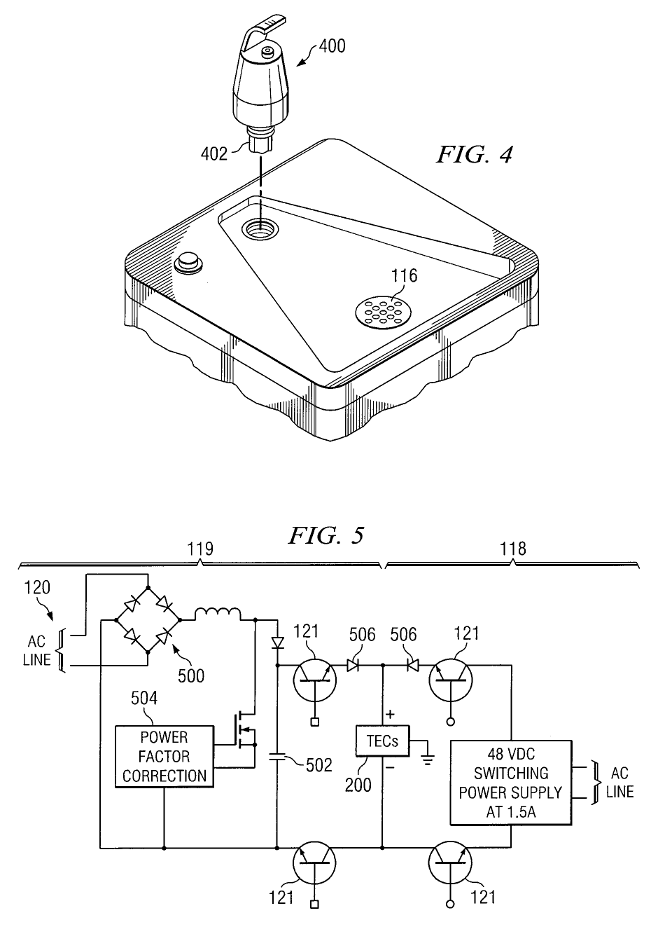

FIG. 4 is a schematic of a water filter/bubbler combination unit 400, a replaceable filter 402, and drain 116. In this embodiment, dispenser 108 is a water filter/bubbler combination unit 400 that is coupled to water cooler 100 in any suitable manner, such as a screwed connection for ease of replacement. Water filter/bubbler combination unit 400 is coupled to a replaceable filter 402 for filtering water dispensed from the water filter/bubbler combination unit 400, and a drain 116 for capturing at least some of the water dispensed and diverting the water to main drain 128.

Replaceable filter 402 is any suitable water filter that is replaceable. In one example, replaceable filter 402 is integral with water filter/bubbler combination unit 400. To replace the integral replaceable filter 402, both water filter/bubbler combination unit 400 and replaceable filter 402 are replaced. In other examples, replaceable filter 402 is a replaceable cartridge that separates from water filter/bubbler combination unit 400 so that the cartridge is replaced without having to replace water filter/bubbler combination unit 400.

FIG. 5 is a schematic of a dual power supply for water cooler 100 that uses an AC/DC non-isolated power supply for full power supply 119 and a AC/DC power supply for standby power supply 118. To switch between full power supply 119 and standby power supply 118, transistors switches 121 are utilized to isolate the positive leg and return legs of each power supply from each other. One power supply is turned on at a time or both are turned off. Diodes 506 are utilized to protect current from flowing the wrong way.

Power supply 120 is rectified by a bridge rectifier 500 and filtered with a capacitor 502 to provide a non-isolated DC power to drive thermoelectric coolers 200 under a “full” power condition. For example, the DC voltage may range between 150 and 170V DC in full power supply 119 when connected to a 115V AC±10% power line (power supply 120). In one embodiment, bridge rectifier 500 includes four diodes that take a sinusoidal waveform input and inverts the negative going portion of the wave providing an all positive waveform ∩∩∩∩∩, with the peaks at @ 160 Volts. Filter capacitor 502 is sized to the current capacity of thermoelectric coolers 200 such that there is typically less than a 10% ripple on the average output of capacitor 502. The capacity takes the all positive waveform ∩∩∩∩∩ and turns it into a DC voltage, (1.414×120V AC=160V DC). An optional power factor correction circuit 504 may help to balance out the voltage and current draw from the line.

Standby power supply 118 is an isolated switching power supply that delivers “maintenance” power to thermoelectric coolers 200. This maintenance power is used to minimize the thermal short that exists and provides low power cooling to maintain water in water reservoir 102 at the desired temperature. In one embodiment, standby power supply 118 may provide 12, 24, 36 or 48V DC and less than about 65 Watts to thermoelectric coolers 200. In current designs, compressors are thermostatically controlled and consume around 500 Watts when they are activated versus 65-75 Watts consumed by supply 118 during normal operation. Any suitable method may be utilized to achieve power levels necessary to exceed competitive performance requirements or ENERGY STAR requirements. For example, an additional 15 Watt supply could be used to apply a very small amount of power to minimize the thermal short that would exist within thermoelectric coolers 200 during an off cycle. In some embodiments, a suitable fuel cell, solar cell or battery may be utilized to power the thermoelectric coolers and other functions of the water cooler instead of AC power source 120.

A chip may refer to a single thermoelectric cooler 200 in some embodiments. Test data for one embodiment of thermoelectric water cooler 100 indicates that three volts per chip (@ 48 Watts) on nineteen chips may provide enough cooling to maintain water reservoir 102 at or below 50° F. in an 90° F. environment with adequate heat pumping capacity. In another embodiment, test data for thermoelectric water cooler 100 shows that using ten volts per chip (@ 435 Watts) may cool water down to 50° F. or below within three to five minutes, providing a near one pass cooling of the incoming water during high usage scenarios.

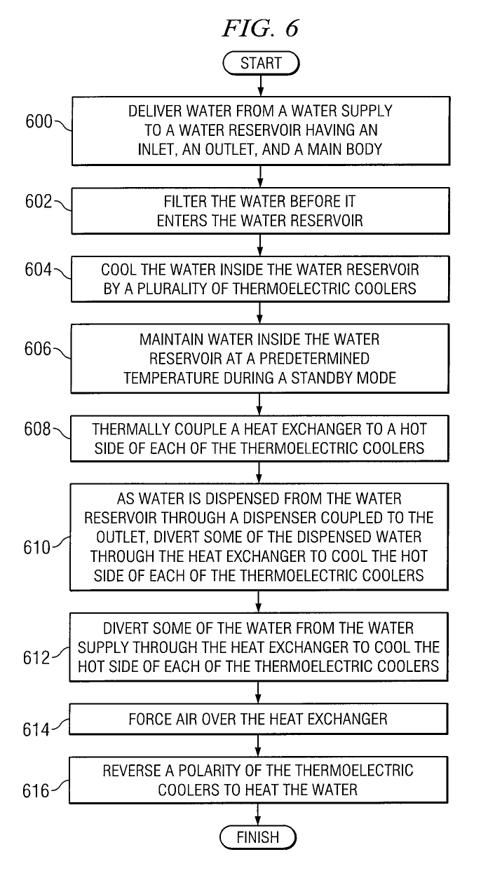

FIG. 6 is a flowchart illustrating an example method of operating thermoelectric water cooler 100. The example method begins at step 600 where water from water supply 106 is delivered to water reservoir 102 having inlet 104, outlet 105, and main body 103. As described above, the water may be filtered, as indicated by step 602, before it enters water reservoir 102. The water inside water reservoir 102 is cooled, at step 604, by thermoelectric coolers 200 disposed about a perimeter of main body 103. Thermoelectric coolers 200 maintain the water inside water reservoir 102 at a predetermined temperature during a standby mode, as indicated by step 606.

Heat exchanger 300 is thermally coupled to a hot side 308 of each of thermoelectric coolers 200, at step 608. During a use mode, as water is dispensed from water reservoir 102 through dispenser 108 coupled to outlet 105, some of the dispensed water is diverted through heat exchanger 300 by a drain 116 to cool the hot side 308 of each of the thermoelectric coolers 200, as indicated by step 610. In addition, as described above, some of the water from water supply 106 may be diverted through heat exchangers 300 for the same purpose, as indicated by step 612. As an additional cooling method or option, air may be forced over heat exchanger 300 by fan 132, as indicated by step 614. And when a user desires hot water instead of cool water from water cooler 100, thermoelectric coolers 200 may be reversed to heat the water, as indicated by step 616.

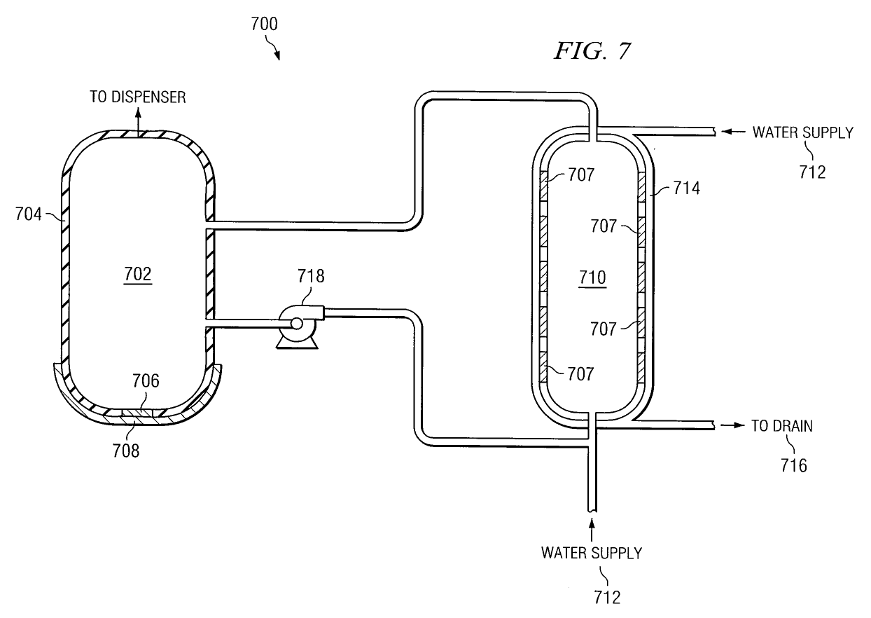

FIG. 7 is a schematic of a water reservoir system 700 for use in a thermoelectric water cooler. In this embodiment, a maintenance reservoir 702 includes any suitable insulation 704 and one thermoelectric cooler 706 coupled to an outside surface of maintenance reservoir 702. Thermoelectric cooler 706 is coupled to a bottom of reservoir 702; however, other suitable locations are possible. A suitable heat sink 810 is coupled to the hot side of thermoelectric cooler 706 to help remove heat generated by thermoelectric cooler 706.

Thermoelectric cooler 706, which may be similar to thermoelectric coolers 200 discussed above, is utilized to cool the water within maintenance reservoir 702 and maintain the water at a desired temperature (e.g., 50° F.±3° F.) with the help of insulation 704 and natural convection cooling. In one embodiment, the single thermoelectric cooler 200 may accept a power of twelve volts and may cool water within maintenance reservoir 702 to 50° F. in a 90° F. ambient environment. Maintenance reservoir 702 is of any suitable size and shape and is formed from any suitable material.

Water reservoir 702 receives water from a secondary water reservoir 710, which receives supply water from a suitable water supply 712. Secondary water reservoir 710 may be any suitable size and shape and be formed from any suitable material and includes a plurality of thermoelectric coolers 707 surrounding an outside surface of secondary water reservoir 710. A suitable heat exchanger 714 is coupled to the hot side of each thermoelectric cooler 707 and receives cooling water from water supply 712. After traveling through heat exchanger 714, the cooling water exits to a drain 716. Thermoelectric coolers 707 cool the water within reservoir 710 to any suitable temperature in any suitable amount of time and in any suitable environment. Any suitable power may be delivered to thermoelectric coolers 707, such as one volt per thermoelectric cooler 707.

In one embodiment of FIG. 7, maintenance reservoir 702 may be utilized, by using a suitable pump 718, to recirculate some of the water inside maintenance reservoir 702 through secondary water reservoir 710 for additional cooling purposes when needed. The recirculated water may enter secondary water reservoir 710 through the bottom and exit out the top before being returned to maintenance reservoir 702.

FIG. 8 illustrates a cross-section of water reservoir 102, heat exchangers 300, a plurality of staged coolers 800, and polyurethane foam 801. In some embodiments, polyurethane foam 801 is omitted. Heat exchanger 300 includes a base plate 301 coupled on one side to hot sides 308 of staged coolers 800 and on the other side to fins 302. Cooling channels 304 and 306 may be formed in base plates 301 and/or fins 302. In some embodiments, heat exchanger 300 is omitted. Each two staged cooler 800 includes an electrical insulator 802, a first thermoelectric cooler 804 (first stage), a heat transfer plate 806, a second thermoelectric cooler 808 (second stage), and a heat sink 810. Thermoelectric coolers 804 and 808 can include one or more elements. Water cooler 100 includes staged coolers 800 in spaced relation around the periphery of water reservoir 102. Staged coolers 800 are placed on the four sides of a rectangular reservoir, but water cooler 100 may include any number and arrangement of staged coolers 800. For example, a similar arrangement of staged coolers 800 may be placed on one or two sides of water reservoir 102. Although illustrated with two stages, staged coolers 800 incorporates any number of stages or arrangements of thermoelectric coolers, insulators, heat transfer plates, and the like.

Fins 302 refer to any suitable structure or arrangement of structures that provide surface area for free convection or conduction cooling to lower the temperature of hot sides 308. Fins 302 are formed from any suitable material and have any suitable size and shape. In one embodiment, fins 302 of heat exchanger 300 provide enough surface area to remove sufficient heat from the hot sides 308 of staged coolers 800 to lower the temperature in water reservoir 102 to the desired temperature. In other embodiments, it is necessary to remove heat by forced convection using a fan or other circulating device or by running liquid through heat exchanger 300. In some cases, the liquid is water.

Cooling channels 304 and 306 refer to any suitable conduits that provide forced convection cooling of hot sides 308 of staged coolers 800. Cooling channels 304, 306 allow liquid, such as water, to pass through heat exchangers 300 to cool hot sides 308 of staged coolers 800. In some embodiments, cooling channels 304, 306 are coupled to a drain, a manifold, or a reservoir. For example, cooling channels 304, 306 are coupled to drain 116 (FIG. 1) to allow water to flow from drain 116 through heat exchanger 300 to provide cooling to hot sides 308 of staged coolers 800. In another example, cooling channels 304 and 306 couple to manifold 114 (FIG. 1) to allow water stored in manifold 114 to flow through heat exchanger 300 for the cooling of hot side 308 of staged coolers 800. The use of either cooling channel 304, cooling channel 306, or both cooling channels 304 and 306, is controlled by controller 124 (FIG. 1).

Electrical insulator 802 refers to a layer of material that electrically insulates water reservoir 102 from staged coolers 800 or other electrical component. Electrical insulator 802 is made of any suitable material that is electrically insulative and thermally conductive. In some cases, a portion of electrical insulator 802 is made of alumina ceramic. Electrical insulator 802 couples to first thermoelectric cooler 804 and water reservoir 102. In some cases, electrical insulator 802 is omitted and/or integrated into another component of thermoelectric water cooler 100. In one example, thermoelectric coolers 804 and 808 are made of an electrically insulative material, such as a ceramic, which provides electrical insulation from other components. Electrical insulator 802 is not necessary in this instance and may be omitted. In another example, water reservoir 102 has an outside surface that is electrically insulative and thus, electrical insulator 802 is not necessary.

Heat transfer plate 806 couples between first thermoelectric cooler 804 and second thermoelectric cooler 808 to promote heat transfer through staged cooler 800. Heat transfer plate 806 refers to any suitable layer of material that provides contacting surfaces for transferring heat between the two components. Heat transfer plate 806 is any suitable thickness and is made of any suitable material for transferring heat. For example, heat transfer plate 806 may be aluminum or copper plate. Heat transfer plate 806 couples first thermoelectric cooler 804 to second thermoelectric cooler 808 to transfer heat between thermoelectric coolers 804 and 808. Heat transfer plate 806 contacts a portion of surfaces of first and second thermoelectric coolers 804 and 808.

Heat sink 810 refers to any structure that absorbs and dissipates heat from a component that is thermally coupled to heat sink 810. Heat sink 810 is made of any suitable material with thermal conductivity to promote heat transfer. For example, heat sink 810 may be made of copper or aluminum. Heat sink 810 couples second thermoelectric cooler 808 to heat exchanger 300 to remove heat away from second thermoelectric cooler 808 to heat exchanger 300. In some cases, heat sink 810 is omitted and/or integrated into another component of thermoelectric water cooler 100. For example, heat exchanger 300 may sufficiently remove heat from second thermoelectric cooler 808 so that heat sink 810 may be omitted or integrated into heat exchanger 300.

Staged cooler 800 cools water in water reservoir 102. First thermoelectric cooler 804 removes heat from water reservoir 102 to reduce the temperature of water in water reservoir 102. Heat transfer plate 806 transfers the heat from first thermoelectric cooler stage 804 to second thermoelectric cooler stage 808. Second thermoelectric cooler stage 808 removes the heat from heat transfer plate 806 and transfers the heat to heat sink 810 to be removed by heat exchanger 300 or directly to the surrounding air. In some cases, heat is dissipated to the surrounding air by a device such as fan 132 in FIG. 1.

Staged cooler 800 heats water in water reservoir 102 by reversing polarity and heat exchange. Heat exchanger 300 and heat sink 810 may be omitted in some cases. Second thermoelectric cooler 808 removes heat from the surrounding air. Heat transfers from second thermoelectric cooler stage 808 to first thermoelectric cooler stage 804 through heat transfer plate 806. First thermoelectric cooler 804 removes heat from heat transfer plate 806 and transfers heat to the walls of water reservoir 102 through electrical insulator 802 to increase the temperature of water inside.

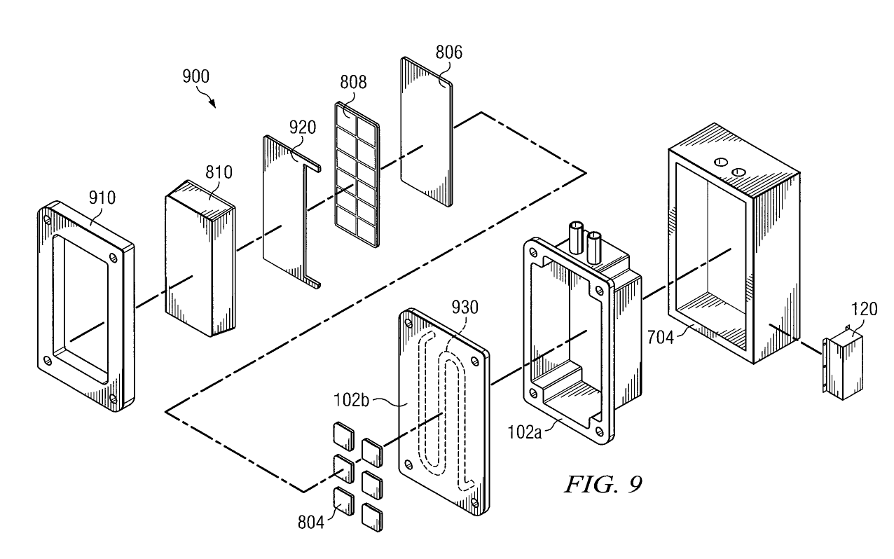

FIG. 9 illustrates a schematic of a multistage water cooler 900 that incorporates a multi-stage thermoelectric cooling technique. Multistage water cooler 900 includes water reservoir 102 having a container 102A and a cover 102B. Multistage water cooler 900 also includes an exit tube manifold 930 coupled to cover 102B to cool water within and surrounding. Multistage water cooler 900 also includes first thermoelectric cooler stage 804 coupled to cover 102B to extract heat from water reservoir 102 and exit tube manifold 930. Heat transfer plate 806 couples between first thermoelectric cooler stage 804 and second thermoelectric cooler stage 808 to transfer heat from first thermoelectric cooler stage 804 to second thermoelectric cooler stage 808. In this arrangement, first thermoelectric cooler stage 804 removes heat from water reservoir 102 and second thermoelectric cooler stage 808 remove heat from first thermoelectric cooler stage 804 through heat transfer plate 806.

Multistage water cooler 900 also includes a water cooling manifold 920 coupled between second thermoelectric cooler 808 and heat sink 810 to extract heat from second thermoelectric cooler 808. Insulation 704 is coupled to at least a portion of the container 102A to thermally insulate the water reservoir 102. Multistage water cooler 900 also includes a mounting bracket 910 for mounting multistage water cooler 900 to a structure and a power supply 120 to provide power to multistage water cooler 900.

First thermoelectric cooler stage 804 is thermally coupled to cover 102B to remove heat from water reservoir 102 to reduce or maintain the temperature of water within and to remove heat from exit tube manifold 930 to reduce the temperature of water within. Cover 102B is made of any suitable material that is thermally conductive such as copper plate. Insulation 704 partially covers water reservoir 102 to thermally insulate water reservoir 102. Insulation 704 may also include a portion that electrically insulates first thermoelectric cooler 804 from water reservoir 102. Heat transfer plate 806 thermally couples to and promotes heat transfer between first thermoelectric cooler stage 804 and second thermoelectric cooler stage 808. Second thermoelectric cooler stage 808 is thermally coupled to heat transfer plate 806 operates to remove heat from heat transfer plate 806 and from first thermoelectric cooler stage 804.

Water cooling manifold 920 is any suitable manifold for removing heat from second thermoelectric cooler stage 808. In a particular embodiment, water flows into water cooling manifold 920 from water supply 106 and out of water cooling manifold 920 to drain 128. Some embodiments of multistage water cooler 900 may not need a water cooling manifold 920. For example, in a multistage water cooler 900 that heats water in water reservoir 102, water cooling manifold 920 may be omitted. In another example, fan 132 may be used instead of water cooling manifold 920 to remove heat.

Water cooling manifold 920 thermally couples to and removes heat from second thermoelectric cooler stage 808. Heat sink 810 is thermally coupled to water cooling manifold 920 to remove heat. In other embodiments, heat sink 810 is thermally coupled to thermoelectric coolers 804 and 808 to remove heat from thermoelectric coolers stages 804 and 808.

Exit tube manifold 930 is any suitable manifold to cool water within and surrounding. In some embodiments of multistage water cooler 900, exit tube manifold 930 is omitted or integrated into another component. In one example, a channel is machined into cover 102B to form exit tube manifold 930. In some embodiments, at least a portion of exit tube manifold 930 is located outside of water reservoir 102. In one example, a portion of exit tube manifold 930 is located between first thermoelectric cooler 804 and thermoelectric cooler 808. Any suitable method is used to couple exit tube manifold 930 to cover 102B.

During full cooling mode, water flows into exit tube manifold 930 from water reservoir 102 and out of exit tube manifold 930 to dispenser 108. Thermoelectric cooler stages 804 and 808 extract heat from water in water reservoir 102 to maintain the water at a predetermined temperature. Thermoelectric cooler stages 804 and 808 extract heat from water in exit tube manifold 930 to cool water below the predetermined temperature.

Similar concepts of multistage water cooler 900 may also adapt to thermoelectric cooler 100 in FIG. 1 with thermoelectric coolers 200 arranged in consecutive stages. Each stage refers to a layer or other arrangement of thermoelectric coolers 200 thermally coupled together to remove heat from the previous stage or in the case of the first stage, from the water reservoir 102. In some cases, heat transfer plate 806 is sandwiched between stages for transferring heat between stages. Multistage water cooler 900 includes a heat transfer plate 806 disposed between two stages of thermoelectric coolers 804 and 808.

Some embodiments of multistage water cooler 900 are more energy efficient than water cooler 100 with a single stage of thermoelectric coolers 200. The energy efficiency of a single thermoelectric cooler 200 is inversely related to a temperature change between a first surface of the thermoelectric cooler 200 being cooled and a second surface of the thermoelectric cooler 200 removing heat. Reducing the temperature change between first and second surfaces of thermoelectric cooler 200 improves the energy efficiency of thermoelectric cooler 200. Assume a total temperature change, Tₜₒₜₐₗ, is defined as the difference between a desired temperature of water in water reservoir 102 and the temperature of heat sink 810 or the ambient temperature. By arranging thermoelectric coolers 200 in N stages, the temperature change required by each stage of thermoelectric coolers is reduced to a portion of the total temperature change Tₜₒₜₐₗ. In one case, the temperature change at each stage is Tₜₒₜₐₗ/N. Thus, arranging thermoelectric coolers in stages reduces the temperature change required at each stage and consequently, improves the energy efficiency of multistage water cooler 900. Test data indicates that one embodiment of multistage water cooler 900 with two stages of thermoelectric coolers 804 and 808 is more efficient than thermoelectric cooler 100 with a single stage where the Tₜₒₜₐₗ is in excess 25° F.

Other embodiments of multistage water cooler 900 have lower operational and maintenance costs. As discussed above, arranging thermoelectric coolers in stages reduces the temperature change required by each stage. Reducing the temperature change at each stage reduces the power requirements for each stage. For N stages, power requirements for thermoelectric coolers are reduced by 1/N in some embodiments. Reducing power requirements improves on wear and tear. In addition, some embodiments use a compact water cooler with no moving parts, which facilitates quiet operation and reduces wear and tear. Consequently, arranging thermoelectric coolers in stages reduces operation and maintenance costs.

One embodiment of multistage water cooler 900 provides improved heat pumping capacity to compete with compressor-based systems in practical operation of the water cooler. In some embodiments, heat pumping capacity of each thermoelectric cooler is limited by a maximum allowable temperature change between the surfaces of each thermoelectric cooler. Stages are added to increase heat pumping capacity while keeping each stage of thermoelectric coolers within the maximum temperature change. Thus, arranging thermoelectric coolers in stages improves heat pumping capacity, in particular at large delta temperatures.

Multistage water cooler 900 may include any suitable number of stages to meet heating/cooling requirements, power restrictions, and other requirements. Each stage may comprise any suitable number of elements. Multistage water cooler 900 includes first and second stages. The first stage includes first thermoelectric cooler 804 with six elements. The second stage includes second thermoelectric cooler 808 with twelve elements.

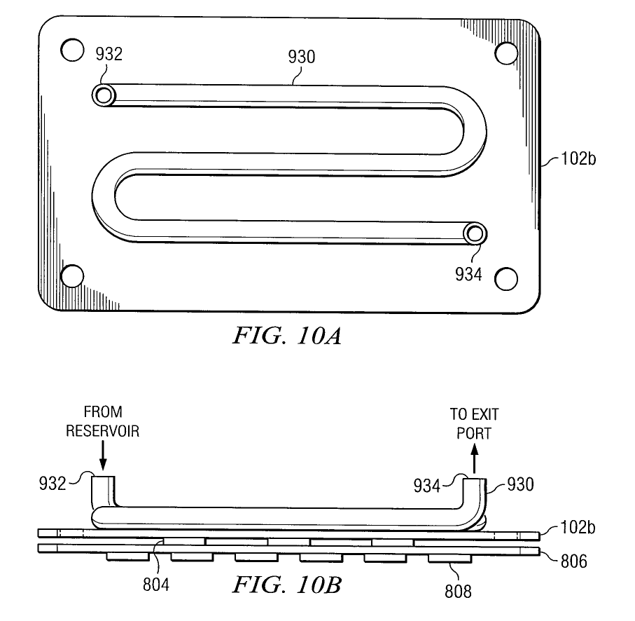

FIG. 10 illustrates a schematic of an exit tube manifold 930, a cover 102B of a water reservoir 102, a two-stage arrangement of thermoelectric cooler stages 804 and 808, and heat transfer plate 806. Exit tube manifold 930 is coupled to cover 102B to cool water within and surrounding. First thermoelectric cooler stage 804 is coupled to cover 102B to extract heat from water reservoir 102 and to extract heat from heat from exit tube manifold 930. Heat transfer plate 806 couples between first thermoelectric cooler 804 and second thermoelectric cooler stage 808 to transfer heat from first thermoelectric cooler 804 to second thermoelectric cooler stage 808. In this arrangement, first thermoelectric cooler stage 804 removes heat from water reservoir 102 and exit tube manifold 930, and second thermoelectric cooler stage 808 removes heat from first thermoelectric cooler stage 804 through heat transfer plate 806.

During full cooling mode, water flows into exit tube manifold 930 from water reservoir 102 through entrance 932. Water flows out of exit tube manifold 930 through exit 934. In one embodiment, water from exit 934 flows to dispenser 108 through components coupled to exit 934. Thermoelectric cooler stages 804 and 808 extract heat from water in water reservoir 102 to maintain the water within at a predetermined temperature. Thermoelectric cooler stages 804 and 808 also extract heat from water in exit tube manifold 930 to cool water within below the predetermined temperature. Although exit tube manifold is shown as circular tubing with two loops, exit tube manifold 930 may be formed of any length and shape.

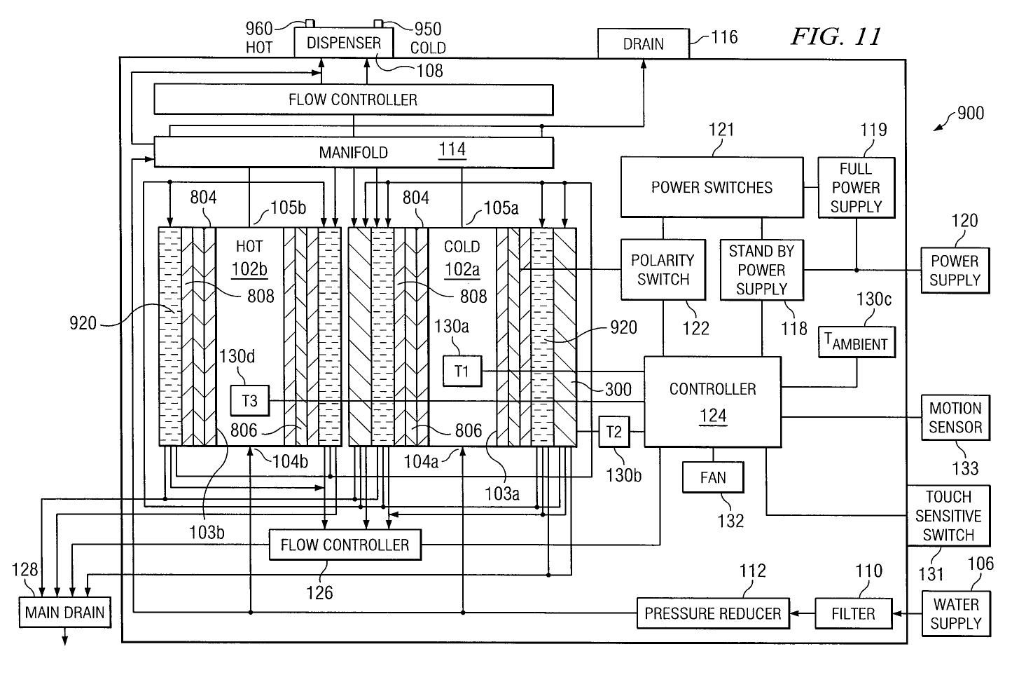

FIG. 11 is a schematic of multistage water cooler 900 having a cold water reservoir 102A and a hot water reservoir 102B. Multistage water cooler 900 also includes water supply 106 and dispenser 108 with hot and cold openings 950, 960. Cold water reservoir 102A includes inlet 104A, outlet 105A, and main body 103A. Cold water reservoir 102A receives water from water supply 106 through inlet 104A and water leaves cold water reservoir 102A through outlet 105A to be dispensed via a cold water opening 950 on dispenser 108 when a user desires cold water. Hot water reservoir 102B includes inlet 104B, outlet 105B, and main body 103B. Hot water reservoir 102B receives water from water supply 106 through inlet 104B and water leaves hot water reservoir 102B through outlet 105B to be dispensed via a hot water opening 960 on dispenser 108 when a user desires hot water. Multistage water cooler 900 also includes first thermoelectric cooler stage 804, second thermoelectric cooler stage 808, heat transfer plates 810, water cooling manifold 920, water heating manifold 940, and heat exchanger 300. The illustrated embodiment may be applicable for any suitable water cooler and/or heater such as an under the sink application, stand-alone fountain, wall-mounted fountain, table-top application, or other device.

Two stages of thermoelectric coolers 804 and 808 are disposed about the perimeter of main body 103A to control the temperature of the water inside cold water reservoir 102A. Any suitable number of stages may be used as described above with reference to FIGS. 8 and 9. The first stage includes first thermoelectric cooler stage 804 and the second stage includes second thermoelectric cooler stage 808. First thermoelectric coolers 804 are disposed around the perimeter of cold water reservoir 102A and remove heat from main body 103A to reduce the temperature of water inside cold water reservoir 102A. Heat transfer plate 806 is coupled to and promotes heat transfer between first and second thermoelectric cooler stages 804 and 808. Second thermoelectric cooler stage 808 extract heat from heat transfer plate 806. The second thermoelectric cooler stage 808 is also coupled to water cooling manifold 920. In some embodiments, cold water from water supply 106, from manifold 114, from heating water manifold 940, or from another suitable source flows through water cooling manifold 920 to remove heat from second thermoelectric coolers 808. Water leaves water cooling manifold 920 to be disposed of through main drain 128 or drain 116, or alternatively to be diverted into water heating manifold 940. Heat exchanger 300 is coupled to water cooling manifold 920 and removes heat to the surrounding air.

Two stages of thermoelectric coolers 804 and 808 are also disposed about the perimeter of main body 103B to control the temperature of the water inside hot water reservoir 102B. The first stage includes first thermoelectric coolers 804 and the second stage includes second thermoelectric coolers 808. First thermoelectric coolers 804 are disposed around the perimeter of hot water reservoir 102B to add heat to main body 103B to increase the temperature of water inside hot water reservoir 102B. Heat transfer plate 806 is coupled to and promotes heat transfer between first and second thermoelectric cooler stages 804 and 808. Second thermoelectric cooler stage 808 are coupled between heat transfer plate 806 and water heating manifold 940. Water from water supply 106, manifold 114, water cooling manifold 920, or other suitable source of hot water flows through water heating manifold 940 to add heat to second thermoelectric coolers 808. Water leaves water heating manifold 940 to be disposed of through main drain 128 or drain 116, or alternatively to be diverted into water cooling manifold 920. In another embodiment, a resistive heating element is used to heat the water in hot water reservoir 102B instead of thermoelectric coolers 804 and 808.

Thermoelectric cooler stages 804 and 808 cool water stored in cold water reservoir 102A and maintain the water at a predetermined temperature during a standby mode when multistage water cooler 900 is not in use. In one embodiment, the water in cold water reservoir 102A is maintained at a temperature of 50° F. The water temperature in cold water reservoir 102A varies with the amount of power delivered to thermoelectric coolers 804 and 808 by standby power supply 118 or full power supply 119.

Thermoelectric coolers 804 and 808 heat water stored in hot water reservoir 102B and maintain the water at a predetermined temperature during a standby mode when multistage water cooler 900 is not in use. In one embodiment, the water in hot water reservoir 102B is maintained at a temperature of 163° F. The water temperature in hot water reservoir 102B varies with the amount of power delivered to thermoelectric coolers 804 and 808 by standby power supply 118 or full power supply 119.

A user operates dispenser 108 to obtain water from water reservoir 102 via flow controller 109. Dispenser 108 includes a hot opening 960 for dispensing hot water and a cold opening 950 for dispensing cold water. Dispensers may include integral or replaceable filters.

A touch sensitive switch 131 allows the user to control flow controller 109 in order to dispense water from water reservoir 102. Touch sensitive switch 131 turns flow controller 109 on and off and meets the American Disabilities Act requirements. As one example, touch sensitive switch 131 is one of the QT110 Family Qtouch™ Sensor ICs by Quantum Research Group.

Water flows through water cooling manifold 920 proximate the hot side of thermoelectric cooler stages 804 and 808 if the temperature of such water is cooler than the ambient temperature to improve system performance. If the water does not provide adequate cooling in a low power use mode within a certain time frame, full power supply 119 or standby power supply 118 is then used to cool the temperature of water in cold water reservoir 102A to the desired temperature. If the temperature of water in cold water reservoir 102A drops below a predetermined threshold, e.g. 46° F., power to thermoelectric cooler stages 804 and 808 are turned off and heating is used if the ambient temperature drops below freezing (32° F.) by activating polarity switch 122.

Water also flows through water heating manifold 940 proximate the cold side of thermoelectric cooler stages 804 and 808 if the temperature of such water is hotter than the ambient temperature to improve system performance. If the water does not provide adequate heating in a low power use mode within a certain time frame, full power supply 119 or standby power supply 118 is then used to heat the temperature of water in hot water reservoir 102B to the desired temperature. If the temperature of water in hot water reservoir 102A rises above a predetermined threshold, e.g. 212° F., power to thermoelectric cooler stages 804 and 808 is turned off and cooling is used by activating polarity switch 122.

At least some of the cold water that is being dispensed is collected and drained by drain 116. This cold water is diverted to either main drain 128 or utilized within heat exchanger 300 or water cooling manifold 920 for cooling thermoelectric coolers 200. During the use mode, when a user is obtaining water through dispenser 108, additional power is delivered to thermoelectric cooler stages 804 and 808 by either full power supply 119 or standby power supply 118 in order to keep the water within water reservoir 102 at the desired temperature.

Although any suitable power delivery is used, power is delivered to thermoelectric coolers 804 and 808 via one of two power supplies 118 or 119 via power supply 120 from a standard wall socket or power cord. A fuse or circuit breaker is used to provide safety protection.

A polarity switch 122 reverses the polarity of thermoelectric coolers 804 and 808 in order to change from cooling to heating water or heating to cooling water. For example, if ambient temperature drops below 32° F., then polarity switch 122 switches the polarity of thermoelectric coolers 804 and 808 in order to heat the water in cold water reservoir 102A.

A suitable controller 124 is utilized to control the power delivered to thermoelectric cooler stages 804 and 808 in addition to controlling other functions of multistage water cooler 900, such as the switching of the power supplies via switches 121, the switching of the polarity delivered to thermoelectric coolers 200, the use of heat exchanger 300, optional fan 132, and other suitable functions. Any suitable controller is used and independent analog circuitry may also be utilized.

Controller 124 is coupled to temperature sensors 130a, 130b, 130c, 130d in order to maintain the temperature of the water in water reservoirs 102A, 102B under different environmental and use conditions. For example, if ambient temperature rises, as detected by temperature sensor 130c, then it is likely the temperature of water in cold water reservoir 102A, as detected by temperature sensor 130a, will rise. Controller 124 either directs more power to be delivered to thermoelectric coolers 804 and 808 or directs drain water from drain 116 or water stored in manifold 114 through heat exchanger 300 in order to keep the temperature of the water within water reservoir 102 at the desired temperature.

Heat removed by each stage of thermoelectric coolers 804 and 808 may be selectively controlled. For example, one or more controllers 124 adjusts the power input to each stage of thermoelectric coolers 804 and 808 to selectively control the amount of heat removed by each stage. In some cases, one or more controllers 124 adjust the power based on the dynamic requirements of multistage water cooler 900. For example, when ambient temperature is close to the desired temperature of the water in cold water reservoir 102, one or more controllers 124 lower power input into the first stage to a minimal maintenance power level and turn off the power to the other stages. In another embodiment, one or more controllers 124 are used to selectively adjust the power input to individual thermoelectric coolers 200.

Modifications, additions, or omissions may be made to thermoelectric water cooler 900 without departing from the scope of the invention. The components of thermoelectric water cooler 900 may be integrated or separated according to particular needs. Moreover, the functions of thermoelectric water cooler 900 may be performed by more, fewer, or other components.

Although embodiments of the invention and their advantages are described in detail, a person skilled in the art could make various alterations, additions, and omissions without departing from the spirit and scope of the present invention.

What is claimed is:

1. A system for controlling the temperature of water in a water reservoir, comprising:
a water reservoir;
an inlet operable to deliver water to the water reservoir;
an outlet operable to dispense at least a portion of the water from the water reservoir; and
a staged water cooler having a first thermoelectric cooler stage coupled to a second thermoelectric cooler stage, the staged water cooler operable to control the temperature of the water in the water reservoir.

2. The system of claim 1, further comprising a manifold coupled to the staged water cooler and coupled to the water reservoir, the manifold includes water from the water reservoir and is operable to extract heat from the water.

3. The system of claim 1, further comprising a heat transfer plate coupled to the first thermoelectric cooler and the second thermoelectric cooler, the heat transfer plate operable to transfer heat from the first thermoelectric cooler stage to the second thermoelectric cooler stage.

4. The system of claim 1, further comprising:
a heat transfer plate coupled to the first thermoelectric cooler stage and the second thermoelectric cooler stage, the heat transfer plate operable to transfer heat from the first thermoelectric cooler stage to the second thermoelectric cooler stage; and
a heat sink coupled to the second thermoelectric cooler stage, the heat sink operable to extract heat from the second thermoelectric cooler stage.

5. The system of claim 1, further comprising a heat exchanger coupled to the staged water cooler, the heat exchanger operable to extract heat from the staged water cooler and to dissipate the extracted heat.

6. The system of claim 1, further comprising a heat exchanger having:
a base plate coupled to the staged water cooler and operable to extract heat from the staged water cooler; and
a plurality of fins coupled to the base plate and operable to extract heat from the base plate and dissipate the extracted heat.

7. The system of claim 1, further comprising a heat exchanger having:
a base plate coupled to the staged water cooler;
a plurality of fins coupled to the base plate and operable to extract heat from the base plate and dissipate a portion of the heat extracted from the base plate; and
a conduit coupled to the plurality of fins and operable to extract heat from the plurality of fins.

8. The system of claim 1, further comprising a thermal insulator operable to thermally insulate the water reservoir, wherein the water reservoir comprises a first portion opposing a second portion, the thermal insulator coupled to the first portion of the water reservoir, the staged water cooler coupled to the second portion of the water reservoir.

9. The system of claim 1, further comprising a manifold coupled to the staged water cooler, the manifold includes circulating water and is operable to extract heat from the staged water cooler.

10. A staged water cooler, comprising:
a water reservoir operable to hold water;
a first thermoelectric cooler stage coupled to the water reservoir and operable to extract heat from the water in the water reservoir; and
a second thermoelectric cooler coupled to the first thermoelectric cooler stage, the second thermoelectric cooler stage operable to extract heat from the first thermoelectric cooler stage.

11. The staged water cooler of claim 10, further comprising a heat transfer plate coupled to the first thermoelectric cooler stage and the second thermoelectric cooler stage, the heat transfer plate operable to transfer heat from the first thermoelectric cooler to the second thermoelectric cooler.

12. The staged water cooler of claim 10, further comprising:
a heat transfer plate coupled to the first thermoelectric cooler stage and the second thermoelectric cooler stage, the heat transfer plate operable to transfer heat from the first thermoelectric cooler stage to the second thermoelectric cooler stage; and
a heat sink coupled to the second thermoelectric cooler stage, the heat sink operable to extract heat from the second thermoelectric cooler stage.

13. The staged water cooler of claim 10, further comprising a heat exchanger coupled to the second thermoelectric cooler stage, the heat exchanger operable to extract heat from the second thermoelectric cooler stage and to dissipate the extracted heat.

14. The staged water cooler of claim 10, further comprising a heat exchanger having:
a base plate coupled to the second thermoelectric cooler stage and operable to extract heat from the second thermoelectric cooler stage; and
a plurality of fins coupled to the base plate and operable to extract heat from the base plate and to dissipate the extracted heat.

15. The staged water cooler of claim 10, further comprising a heat exchanger having:
a base plate coupled to the stated water cooler;
a plurality of fins coupled to the base plate and operable to extract heat from the base plate and dissipate a portion of the heat extracted from the base plate; and
a conduit coupled to the plurality of fins and operable to extract heat from the plurality of fins.

16. The staged water cooler of claim 10, further comprising a thermal insulator operable to thermally insulate the water reservoir, wherein the water reservoir comprises a first portion opposing a second portion, the thermal insulator coupled to the first portion of the water reservoir, the first thermoelectric cooler stage coupled to the second portion of the water reservoir.

17. The system of claim 10, further comprising a manifold coupled to the second thermoelectric cooler stage, the manifold includes circulating water and is operable to extract heat from the second thermoelectric cooler stage.

18. A system for controlling the temperature of water in a hot water reservoir and a cold water reservoir, comprising:
a hot water reservoir;
a cold water reservoir;
a water supply operable to deliver water to the cold water reservoir and to the hot water reservoir;
a hot water dispenser operable to dispense a portion of water from the hot water reservoir;
a cold water dispenser operable to dispense a portion of water from the cold water reservoir;
a first staged thermoelectric device having a first thermoelectric stage coupled to a second thermoelectric stage, the first staged thermoelectric device operable to increase the temperature of water in the hot water reservoir; and
a second staged thermoelectric device having a third thermoelectric stage coupled to a fourth thermoelectric stage, the second staged thermoelectric device operable to decrease the temperature of water in the cold water reservoir.

19. The system of claim 18, further comprising:
a first heat transfer plate coupled to the first thermoelectric stage and the second thermoelectric stage, the heat transfer plate operable to transfer heat from the second thermoelectric stage to the first thermoelectric stage, the first thermoelectric stage coupled to the hot water reservoir; and
a second heat transfer plate coupled to the third thermoelectric stage and the fourth thermoelectric stage, the heat transfer plate operable to transfer heat from the third thermoelectric stage to the fourth thermoelectric stage, the third thermoelectric coupled to the cold water reservoir.

20. The system of claim 18, further comprising:
a first heat transfer plate coupled to the first thermoelectric stage and the second thermoelectric stage, the heat transfer plate operable to transfer heat from the second thermoelectric stage to the first thermoelectric stage, the first thermoelectric stage coupled to the hot water reservoir;
a second heat transfer plate coupled to the third thermoelectric stage and the fourth thermoelectric stage, the heat transfer plate operable to transfer heat from the third thermoelectric stage to the fourth thermoelectric stage, the third thermoelectric stage coupled to the cold water reservoir; and
a heat sink coupled to the fourth thermoelectric stage, the heat sink operable to extract heat from the fourth thermoelectric.

21. The system of claim 18, further comprising:
a first manifold coupled to the second thermoelectric cooler stage, the first manifold includes circulating water and is operable to add heat to the second thermoelectric stage; and
a second manifold coupled to the fourth thermoelectric cooler stage, the second manifold includes circulating water and is operable to extract heat from the fourth thermoelectric stage.

22. The system of claim 18, further comprising:
a first manifold coupled to the second thermoelectric stage, the first manifold includes circulating fluid and is operable to add heat to the second thermoelectric stage; and
a second manifold coupled to the fourth thermoelectric stage, the second manifold includes circulating fluid and is operable to extract heat from the fourth thermoelectric stage,
wherein:
a portion of the circulating fluid flowing out of the first manifold is diverted into the second manifold, and
a portion of the circulating fluid flowing out of the second manifold is diverted into the first manifold.

23. The system of claim 18, further comprising a heat exchanger coupled to the fourth thermoelectric stage, the heat exchanger operable to extract heat from the fourth thermoelectric stage and to dissipate the extracted heat.

24. The system of claim 18, further comprising a heat exchanger having:
a base plate coupled to the fourth thermoelectric stage and operable to extract heat from the fourth thermoelectric stage; and
a plurality of fins coupled to the base plate and operable to extract heat from the base plate and to dissipate the extracted heat.

25. A method for controlling the temperature of the water in a water reservoir, comprising:
receiving water at a water reservoir;
extracting heat from the water in the water reservoir using a first thermoelectric cooler stage; and
extracting heat from the first thermoelectric cooler stage using a second thermoelectric cooler.

26. The method of claim 25, further comprising transferring heat from the first thermoelectric cooler stage to the second thermoelectric cooler stage using a heat transfer plate.

27. The method of claim 25, further comprising:
transferring heat from the first thermoelectric cooler stage to the second thermoelectric cooler stage using a heat transfer plate; and
extracting heat from the second thermoelectric cooler using a heat sink.

28. The method of claim 25, further comprising:
extracting heat from the second thermoelectric cooler stage using a heat exchanger; and
dissipating the extracted heat from the second thermoelectric cooler stage using the heat exchanger.

29. The method of claim 25, further comprising:
extracting heat from the second thermoelectric cooler stage using a base plate of a heat exchanger;
extracting heat from the base plate of the heat exchanger using a plurality of fins of the heat exchanger; and
dissipating heat from the base plate using the plurality of fins coupled to the base plate.

30. The method of claim 25, further comprising:
extracting heat from the second thermoelectric cooler stage using a base plate of a heat exchanger;
extracting heat from the base plate of the heat exchanger using a plurality of fins of the heat exchanger;
extracting heat from the plurality of fins by flowing fluid through a conduit coupled to the plurality of fins; and
dissipating heat from the base plate using the plurality of fins.

31. The method of claim 25, further comprising insulating the water reservoir using a thermal insulator, the water reservoir comprising a front portion opposite a back portion, the thermal insulator covering the back portion of the water reservoir, the staged water cooler coupled to the front portion of the water reservoir.

32. The method of claim 25, further comprising flowing fluid through a manifold coupled to the second thermoelectric cooler stage to extract heat from the second thermoelectric cooler stage.

33. The method of claim 25, further comprising electrically insulating the water reservoir using an electrical insulator coupled between the water reservoir and the first thermoelectric cooler stage.

34. The method of claim 25, further comprising dispensing the water from the water reservoir for drinking by a user in response to user activation.

35. A method for controlling the temperature of the water in a hot water reservoir and the temperature of water in a cold water reservoir, comprising:
receiving water at a hot water reservoir;
receiving water at a cold water reservoir;
increasing the temperature of the water in the hot water reservoir using a first staged thermoelectric device having a first thermoelectric stage coupled to a second thermoelectric stage; and
decreasing the temperature of the water in the cold water reservoir using a second staged thermoelectric device having a third thermoelectric coupled to a fourth thermoelectric stage.

36. The method of claim 35, further comprising:
transferring heat from the second thermoelectric stage to the first thermoelectric stage using a first heat transfer plate coupled to the first thermoelectric stage and the second thermoelectric stage, the first thermoelectric stage coupled to the hot water reservoir; and
transferring heat from the third thermoelectric stage to the fourth thermoelectric stage using a second heat transfer plate coupled to the third thermoelectric stage and the fourth thermoelectric stage, the third thermoelectric stage coupled to the cold water reservoir.

37. The method of claim 35, further comprising:
transferring heat from the second thermoelectric stage to the first thermoelectric stage using a first heat transfer plate coupled to the first thermoelectric stage and the second thermoelectric stage, the first thermoelectric coupled to the hot water reservoir;
transferring heat from the third thermoelectric stage to the fourth thermoelectric stage using a second heat transfer plate coupled to the third thermoelectric stage and the fourth thermoelectric stage, the third thermoelectric stage coupled to the cold water reservoir; and
extracting heat from the fourth thermoelectric stage using a heat sink coupled to the fourth thermoelectric stage.

38. The method of claim 35, further comprising:
extracting heat from the fourth thermoelectric using a heat exchanger; and
dissipating the heat extracted from the fourth thermoelectric using the heat exchanger.

39. The method of claim 35, further comprising:
extracting heat from the fourth thermoelectric using a base plate of a heat exchanger;
extracting heat from the base plate of the heat exchanger using a plurality of fins of the heat exchanger; and
dissipating heat from the base plate using the plurality of fins coupled to the base plate.

40. The method of claim 35, further comprising:
circulating fluid through a first manifold to add heat to the second thermoelectric cooler; and
circulating fluid through a second manifold to extract heat from the fourth thermoelectric cooler,
wherein:
a portion of fluid circulating from the first manifold is diverted into the second manifold, and
a portion of fluid circulating from the second manifold is diverted into the first manifold.
